(19) United States
(12) Patent Application Publication
(10) Pub. No.: US 2026/0038895 A1
(43) Pub. Date: Feb. 5, 2026

(54) BATTERY MODULE AND BATTERY PACK COMPRISING THE SAME

(71) Applicant: SK ON CO., LTD., Seoul (KR)

(72) Inventors: Jeong Won KIM, Daejeon (KR); Yun Joo NOH, Daejeon (KR); Gang U LEE, Daejeon (KR)

(21) Appl. No.: 19/274,649

(22) Filed: Jul. 21, 2025

(30) Foreign Application Priority Data
Aug. 1, 2024 (KR) 10-2024-0102621

(51) Int. Cl. H01M 10/48; H01M 10/658; H01M 50/211; H01M 50/284; H01M 50/342; H01M 50/507

(52) U.S. Cl. CPC H01M 10/48; H01M 10/658; H01M 50/211; H01M 50/284; H01M 50/3425; H01M 50/507

(57) ABSTRACT

A battery module is provided. According to an embodiment, the battery module includes a cell assembly including a plurality of battery cells; a busbar assembly including an internal busbar electrically connected to the plurality of battery cells, and a terminal busbar electrically connected to the internal busbar; and a module housing including a module cover covering the cell assembly. The module cover may include a first edge; a second edge of which at least a portion is perpendicular to the first edge; a terminal-accommodating hole accommodating the terminal busbar; a connector-accommodating hole spaced apart from the terminal-accommodating hole; and a venting guide portion disposed to be inclined with respect to the first edge and the second edge, and of which at least a portion faces the terminal-accommodating hole or the connector-accommodating hole.

### CROSS-REFERENCE TO RELATED APPLICATION(S)

This patent document claims the priority and benefits of Korean Patent Application No. 10-2024-0102621 filed on Aug. 1, 2024, the disclosure of which is incorporated herein by reference in its entirety.

### TECHNICAL FIELD

The disclosure and implementations disclosed in this patent document generally relate to a battery module and a battery pack including the same.

### BACKGROUND

Unlike a primary battery, a secondary battery may be charged with and discharged of electricity, and thus may be applied to devices within various fields such as a digital camera, a mobile phone, a laptop computer, a hybrid vehicle, an electric vehicle, an energy storage system (ESS), or the like. The secondary battery may be a lithium-ion battery, a nickel-cadmium battery, a nickel-metal hydride battery, or a nickel-hydrogen battery.

The secondary battery may be manufactured as a pouch-type battery cell having flexibility or a square or cylindrical can-type battery cell, having rigidity. A cell assembly including a plurality of battery cells may be disposed in a module housing to form a battery module.

### SUMMARY

A battery module may include a plurality of battery cells. When and/or conductive particles generated by the battery cells are transferred to a conductive connection portion (e.g., a terminal busbar), heat transfer in the battery module may increase.

According to an aspect of the present disclosure, a battery module and a battery pack, capable of delaying heat transfer, may be provided.

A battery module and a battery pack of the present disclosure may be widely applied to green technology fields such as an electric vehicle, a battery charging station, a solar power generation and a wind power generation using batteries, or the like. In addition, a battery module and a battery pack of the present disclosure may be used in electric vehicles, hybrid vehicles, or the like, which may be eco-friendly, to ameliorate the effects of climate change by suppressing air pollution and greenhouse gas emissions.

A battery module of the present disclosure may include a cell assembly including a plurality of battery cells; a busbar assembly including an internal busbar electrically connected to the plurality of battery cells, and a terminal busbar electrically connected to the internal busbar; and a module housing including a module cover covering the cell assembly. The module cover may include a first edge; a second edge of which at least a portion is perpendicular to the first edge; a terminal-accommodating hole accommodating the terminal busbar; a connector-accommodating hole spaced apart from the terminal-accommodating hole; and a venting guide portion disposed to be inclined with respect to the first edge and the second edge, and of which at least a portion faces the terminal-accommodating hole or the connector-accommodating hole.

According to an embodiment, the venting guide portion may include a first venting guide portion of which at least a portion is located between the terminal-accommodating hole and the connector-accommodating hole, and a second venting guide portion intersecting the first venting guide portion.

According to an embodiment, the first venting guide portion may include a plurality of first venting guide portions disposed to be parallel to each other, and the second venting guide portion may include a plurality of second venting guide portions disposed to be parallel to each other.

According to an embodiment, the terminal-accommodating hole may include a first terminal-accommodating hole and a second terminal-accommodating hole spaced apart from the first terminal-accommodating hole. The first venting guide portion may face the second terminal-accommodating hole. The second venting guide portion may face the first terminal-accommodating hole.

According to an embodiment, the venting guide portion may have a notched shape or a half-cut shape configured to rupture, based on pressure in the battery module.

According to an embodiment, the battery module may further include a sensor assembly including a flexible printed circuit board electrically connected to a sensing terminal configured to sense information of the internal busbar, and a connector electrically connected to the flexible printed circuit board and accommodated in the connector-accommodating hole.

According to an embodiment, the terminal-accommodating hole may be closer to the first edge than the second edge. The connector-accommodating hole may be closer to the second edge than to the first edge.

According to an embodiment, the battery module may further include a heat-resistant sheet covering the cell assembly.

According to an embodiment, the heat-resistant sheet may include a first heat-resistant sheet and a second heat-resistant sheet spaced apart from the first heat-resistant sheet. The battery module may further include a venting space located between the first heat-resistant sheet and the second heat-resistant sheet. The venting guide portion may be located in an upper portion of the venting space.

According to an embodiment, each of the plurality of battery cells may include an electrode assembly, a pouch accommodating the electrode assembly, and an electrode tab connected to the electrode assembly.

A battery module of the present disclosure may include a cell assembly including a plurality of battery cells; a busbar assembly including an internal busbar electrically connected to the plurality of battery cells, and a terminal busbar electrically connected to the internal busbar; a module housing including a module cover covering the cell assembly and an accommodation portion accommodating the cell assembly; and a heat-resistant sheet located between the cell assembly and the module cover. The module cover may include a first edge and a second edge of which at least a portion is perpendicular to the first edge. The heat-resistant sheet may include a first heat-resistant sheet and a second heat-resistant sheet, spaced apart from each other, with a venting space interposed therebetween and disposed to be inclined with respect to the first edge and the second edge.

According to an embodiment, the first heat-resistant sheet may include a first outer side surface parallel to the first edge, a second outer side surface extending from the first outer side surface and parallel to the second edge, and a first inner side surface inclined with respect to the first outer side surface and the second outer side surface. The second heat-resistant sheet may include a third outer side surface parallel to the first edge, a fourth outer side surface extending from the third outer side surface and parallel to the second edge, and a second inner side surface inclined with respect to the third outer side surface and the fourth outer side surface. At least a portion of the venting space may be surrounded by the first inner side surface and the second inner side surface.

According to an embodiment, the battery module may further include a sensor assembly including a flexible printed circuit board electrically connected to a sensing terminal configured to sense information of the internal busbar, and a connector electrically connected to the flexible printed circuit board. The heat-resistant sheet may be located between at least a portion of the cell assembly and the sensor assembly.

According to an embodiment, the module cover may include a venting guide portion disposed to be inclined with respect to the first edge and the second edge. The venting guide portion may be located in an upper portion of the venting space.

A battery pack of the present disclosure may include a plurality of battery modules; and a pack frame accommodating the plurality of battery modules, wherein each of the plurality of battery modules includes: a cell assembly including a plurality of battery cells; a busbar assembly including an internal busbar electrically connected to the plurality of battery cells, a busbar frame supporting the internal busbar, and a terminal busbar electrically connected to the internal busbar; and a module housing including a module cover covering the cell assembly and an accommodation portion accommodating the cell assembly. The module cover may include a first edge; a second edge of which at least a portion is perpendicular to the first edge; a terminal-accommodating hole accommodating the terminal busbar; a connector-accommodating hole spaced apart from the terminal-accommodating hole; and a venting guide portion disposed to be inclined with respect to the first edge and the second edge, and of which at least a portion faces the terminal-accommodating hole or the connector-accommodating hole.

### BRIEF DESCRIPTION OF DRAWINGS

Certain aspects, features, and advantages of the present disclosure may be illustrated by the following detailed description with reference to the accompanying drawings.

FIG. 1 is a perspective view of a battery cell according to an embodiment.

FIG. 2 is a perspective view of a battery module according to an embodiment.

FIG. 3 is an exploded perspective view of a battery module according to an embodiment.

FIG. 4 is a top view of a module cover according to an embodiment.

FIG. 5 is an exploded perspective view of a battery module according to another embodiment.

FIG. 6 is a top view of the battery module of FIG. 5.

FIG. 7 is an exploded perspective view of a battery pack according to an embodiment.

### DETAILED DESCRIPTION

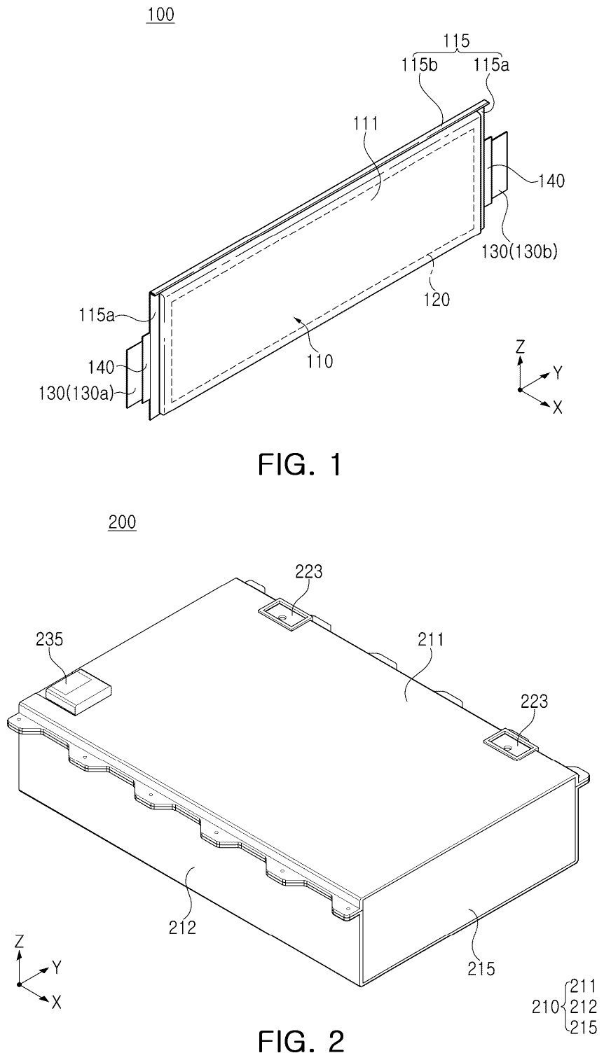

FIG. 1 is a perspective view of a battery cell according to an embodiment.

Referring to FIG. 1, a battery cell 100 may include an electrode assembly 120, a pouch 110 accommodating the electrode assembly 120, and an electrode tab 130 connected to the electrode assembly 120. The battery cell 100 may be a secondary battery. For example, the battery cell 100 may be a lithium ion battery, but is not limited thereto. For example, the battery cell 100 may be a nickel-cadmium battery, a nickel-metal hydride battery, or a nickel-hydrogen battery, capable of being charged with and discharged of electricity.

The pouch 110 may form at least a portion of an exterior of the battery cell 100. The pouch 110 may include an electrode-accommodating portion 111 accommodating the electrode assembly 120, and a sealing portion 115 sealing at least a portion of a circumference of the electrode-accommodating portion 111. The electrode-accommodating portion 111 may provide a space in which the electrode assembly 120 and an electrolyte are accommodated.

The sealing portion 115 may be formed by joining at least a portion of a circumference of the pouch 110. The sealing portion 115 may be formed in a flange shape extending outward from the electrode-accommodating portion 111 formed in a container shape, and may be disposed along at least a portion of outer circumference of the electrode-accommodating portion 111. In an embodiment, the sealing portion 115 may include a first sealing portion 115a in which the electrode tab 130 is located, and a second sealing portion 115b in which the electrode tab 130 is not located. A portion of the electrode tab 130 may be withdrawn or exposed to an outside of the pouch 110.

In an embodiment, the battery cell 100 may include an insulating film 140. In a position in which the electrode tab 130 is withdrawn, to increase a degree of sealing of the first sealing portion 115a and simultaneously secure an electrical insulation state, the electrode tab 130 may be covered by the insulating film 140. The insulating film 140 may be formed of a film material, thinner than the electrode tab 130, and may be attached to both surfaces of the electrode tab 130.

In an embodiment, the electrode tabs 130 may be disposed in opposite directions on both sides of the battery cell 100 in a length direction thereof. For example, the electrode tab 130 may include a cathode tab 130a having first polarity (e.g., cathode) facing one side of the length direction of the battery cell 100, and an anode tab 130b having second polarity (e.g., anode) facing the other side of the length direction of the battery cell 100. In the embodiment illustrated in FIG. 1, the sealing portion 115 may include two first sealing portions 115a on which the electrode tabs 130 are disposed and one second sealing portion 115b on which the electrode tabs 130 are not disposed. The electrode tabs 130 may be referred to as electrode leads.

A direction in which the electrode tabs 130 are located may be selectively designed. In an embodiment, the electrode tabs 130 may include a cathode tab 130a and an anode tab 130b located in an opposite direction of the cathode tab 130a based on the electrode assembly 120. Although FIG. 1 illustrates that the electrode tabs 130 are disposed in opposite directions on both sides of the length direction of the battery cell 100, a structure of the electrode tabs 130 is not limited thereto. For example, two electrode tabs 130 may be arranged to be substantially parallel in the length direction of the battery cell 100. The pouch 110 is not limited to a structure in which a single sheet of outer material is folded to form the sealing portion 115 on three surfaces as illustrated in FIG. 1.

In an embodiment of the present disclosure, at least a portion of the sealing portion 115 may be formed to be folded at least once. At least a portion of the sealing portion 115 may be folded to improve joining reliability of the sealing portion 115 and minimize an area of the sealing portion 115.

The electrode assembly 120 may include a cathode plate, an anode plate, and a separator. The separator may prevent contact between the cathode plate and the anode plate. A person skilled in the art will understand that the electrode is manufactured assembly 120 using various methods. According to example embodiments, the cathode plate, the anode plate, and the separator may be repeatedly disposed to form the electrode assembly. In some embodiments, the electrode assembly may be a winding type, a stacking type, a z-folding type, or a stack-folding type.

The structure of the battery cell 100 illustrated in FIG. 1 is illustrative. For example, in FIG. 1, although the battery cell 100 is illustrated as a pouch-type battery cell, but a structure of the battery cell 100 is not limited thereto. For example, the battery cell 100 may be a cylindrical battery cell or a square battery cell.

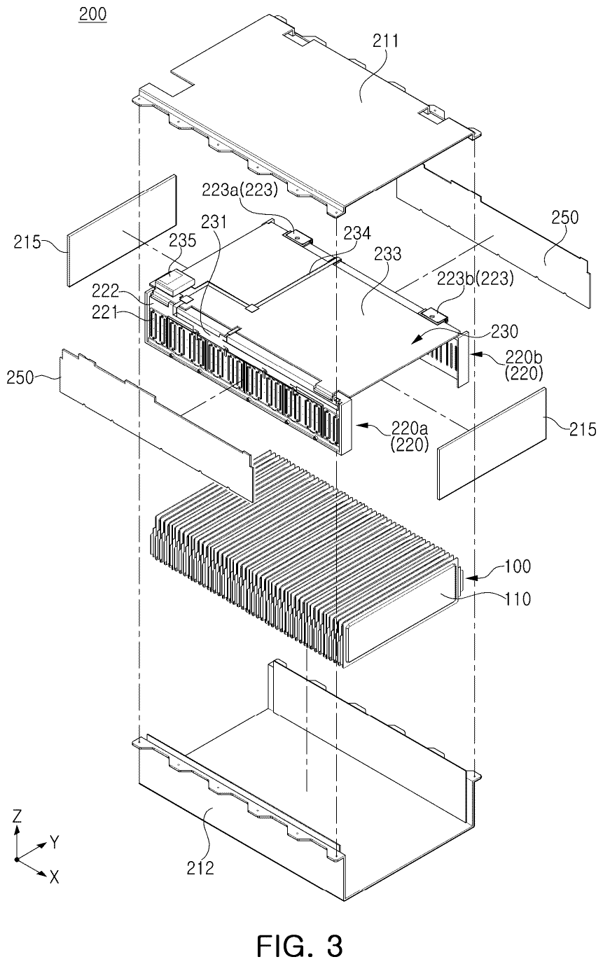

FIG. 2 is a perspective view of a battery module according to an embodiment. FIG. 3 is an exploded perspective view of a battery module according to an embodiment.

Referring to FIG. 2 and/or FIG. 3, a battery module 200 may include a cell assembly 101 including a plurality of battery cells (e.g., battery cells 100 of FIG. 1), a module housing 210, a busbar assembly 220, and/or a sensor assembly 230.

The module housing 210 may form at least a portion of an exterior of the battery module 200. The module housing 210 may accommodate components of the battery module 200 (e.g., a cell assembly 101 and the busbar assembly 220).

The module housing 210 may include a module cover 211. The module cover 211 may cover the cell assembly 101. The module cover 211 may be disposed on one side of the cell assembly 101. The module cover 211 may form at least a portion of the exterior of the battery module 200.

The module housing 210 may include an accommodation portion 212 accommodating the cell assembly 101. The accommodation portion 212 may surround a lower surface and a side surface of the cell assembly 101. In an embodiment, the accommodation portion 212 may include a main plate covering the lower surface of the cell assembly, and a plurality of side wall members covering at least a portion of the side surface of the cell assembly 101. In an embodiment, the main plate and the side wall members may be formed integrally.

The module housing 210 may include an end plate 215 covering a portion of the side surface of the cell assembly 101. In an embodiment, the end plate 215 may be connected to an end portion of the accommodation portion 212.

In an embodiment, the module housing 210 may be formed of a material having high thermal conductivity, such as metal. For example, the module housing 210 may be formed of aluminum and/or stainless steel. The material of the module housing 210 is not limited thereto. In another embodiment, the module housing 210 may be formed of a polymer. In an embodiment, the module housing 210 may be referred to as a module case. A shape of the module housing 210 of the present disclosure is illustrated.

The busbar assembly 220 may include an internal busbar 221. The internal busbar 221 may be electrically connected to a plurality of battery cells 100. For example, each of the plurality of battery cells 100 may include an electrode assembly (e.g., the electrode assembly 120 of FIG. 1), a pouch (e.g., the pouch 110 of FIG. 1) accommodating the electrode assembly 120, and an electrode tab (e.g., the electrode tab 130 of FIG. 1) connected to the electrode assembly 120. The electrode tab 130 may be welded to the internal busbar 221 while being inserted into a slit (not illustrated) of the internal busbar 221.

The busbar assembly 220 may include a busbar frame 222 supporting the internal busbar 221. The busbar frame 222 may be referred to as a support plate or a support frame. The busbar frame 222 may be formed of an electrically insulating material (e.g., a polymer). At least a portion of the busbar frame 222 may be disposed between the cell assembly 101 and the internal busbar 221 to support the internal busbar 221. In an embodiment, the internal busbar 221 may be referred to as a busbar. In an embodiment, the busbar assembly 220 may include a first busbar assembly 220a located on one side of the cell assembly 101 and a second busbar assembly 220b located on the other side of the cell assembly 101.

The busbar assembly 220 may include at least one terminal busbar 223 for electrical connection with the outside of the battery module 200. The electrode tab 130 of the battery cell 100 may be electrically connected to the outside of the battery module 200 through the internal busbar 221 and the terminal busbar 223. For example, the terminal busbar 223 may be electrically connected to the internal busbar 221, and current of the battery cell 100 may be transmitted to the outside of the battery module 200 through the internal busbar 221 and the terminal busbar 223. At least a portion of the terminal busbar 223 may be exposed to an outside of the module housing 210 (e.g., the module cover 211).

In an embodiment, the terminal busbar 223 may be provided in a plurality of pieces. For example, the terminal busbar 223 may include a first terminal busbar 223a having first polarity (e.g., cathode), and a second terminal busbar 223b having second polarity (e.g., anode), different from the first polarity. The first terminal busbar 223a may be spaced apart from the second terminal busbar 223b.

The battery module 200 may include a sensor assembly 230. The sensor assembly 230 may sense information (e.g., temperature and/or voltage) of the battery cell 100.

The sensor assembly 230 may include a flexible printed circuit board 231 electrically connected to a sensing terminal configured to sense information of the internal busbar 221. The flexible printed circuit board 231 may cover a portion of the busbar frame 222. The flexible printed circuit board 231 may provide a path for transmitting a signal. The sensing terminal may be configured to contact the internal busbar 221 and sense information of the internal busbar 221. In an embodiment, the sensing terminal may be a voltage sensor measuring a voltage of the battery cell 100. In an embodiment, the sensing terminal may be a temperature sensor measuring a temperature of the battery cell 100.

In an embodiment, the sensor assembly 230 may include an insulation portion 233. The insulation portion 233 may prevent contact between the cell assembly 101 and the flexible printed circuit board 231 and/or a connection portion 234. The insulation portion 233 may be located between the cell assembly 101 and the connection portion 234 of the flexible printed circuit board 231.

In an embodiment, at least a portion of the flexible printed circuit board 231 may be replaced with a printed circuit board. In an embodiment, the flexible printed circuit board 231 may be disposed on the busbar frame 222 of the first busbar assembly 220a and the busbar frame 222 of the second busbar assembly 220b, respectively.

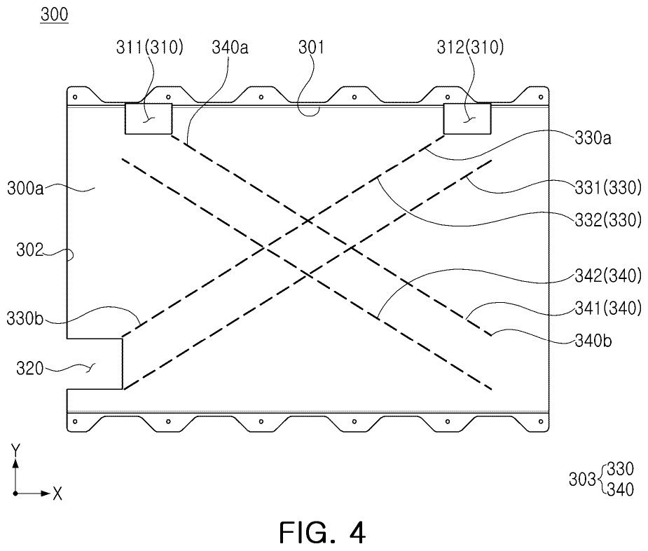

A signal sensed in the sensing terminal may be transmitted to the outside of the battery module 200 through the flexible printed circuit board 231. The sensor assembly 230 may include a connector 235 electrically connected to the flexible printed circuit board 231. At least a portion of the sensor assembly 230 may be exposed to the outside of the battery module 200. For example, the sensor assembly 230 may be accommodated in a connector-accommodating hole (e.g., the connector-accommodating hole 320 of FIG. 4) of the module cover 211. For example, the sensor assembly 230 may include a connection portion 234 connected to the flexible printed circuit board 231 disposed on the first busbar assembly 220a and the flexible printed circuit board 231 disposed on the second busbar assembly 220b. Electrical signals sensed in the first busbar assembly 220a and the second busbar assembly 220b may be transmitted to the connector 235 through the connection portion 234.

In an embodiment, the busbar assembly 220 may be assembled with the sensor assembly 230 to be provided as a single component.

The battery module 200 may include an insulating cover 250 covering at least a portion of the busbar assembly 220. The insulating cover 250 may prevent damage to the busbar assembly 220 and/or the sensor assembly 230 due to external impact. The insulating cover 250 may prevent unintended electrical connection of the busbar assembly 220 and/or the sensor assembly 230.

The insulating cover 250 may prevent contact between the internal busbar 221 of the busbar assembly 220 and a conductive component (e.g., the module housing 210) and between the flexible printed circuit board 231 of the sensor assembly 230 and a conductive component (e.g., the module housing 210). The insulating cover 250 may be located between the accommodation portion 212 of the module housing 210 and the busbar assembly 220.

The insulating cover 250 may be formed of an insulating material. For example, the insulating cover 250 may include a flame retardant polymer. In an embodiment, the insulating cover 250 include flame retardant may polypropylene.

For convenience of explanation, some components will be omitted or exaggerated in this document. For example, the number of battery cells 100, a shape of the module housing 210, and/or a shape of the busbar assembly 220 may be selectively designed.

FIG. 4 is a top view of a module cover according to an embodiment.

Referring to FIG. 4, a module cover 300 may include a terminal-accommodating hole 310, a connector-accommodating hole 320, and a venting guide portion 303. Description of the module cover 211 of FIG. 2 and/or FIG. 3 may be applied to the module cover 300 of FIG. 4.

At least a portion of the module cover 300 may be formed in a rectangular parallelepiped shape. For example, the module cover 300 may include a first edge 301 and a second edge 302 of which at least a portion is perpendicular to the first edge 301. The module cover 300 may include an upper surface 300a having a substantially flat shape. The first edge 301 and the second edge 302 may be edges of the upper surface 300a. The first edge 301 may extend in a first direction (X-axis direction), and the second edge 302 may extend in a second direction (Y-axis direction), perpendicular to the first direction (X-axis direction).

The terminal-accommodating hole 310 may accommodate a terminal busbar (e.g., the terminal busbar 223 of FIG. 3). For example, the terminal-accommodating hole 310 may be a through-hole penetrating a thickness direction of the module cover 300 (e.g., a Z-axis direction of FIG. 3). At least a portion of the terminal busbar 223 may be exposed to the outside of the battery module 200 of FIG. 3 through the terminal-accommodating hole 310.

The terminal-accommodating hole 310 may be provided in plural. For example, the terminal-accommodating hole 310 may include a first terminal-accommodating hole 311 and a second terminal-accommodating hole 312 spaced apart from the first terminal-accommodating hole 311. The first terminal-accommodating hole 311 may accommodate a first terminal busbar (e.g., the first terminal busbar 223a of FIG. 3), and the second terminal-accommodating hole 312 may accommodate a second terminal busbar (e.g., the second terminal busbar 223b of FIG. 3).

The connector-accommodating hole 320 may accommodate a connector (e.g., the connector 235 of FIG. 3). For example, the connector-accommodating hole 320 may be a through-hole penetrating the thickness direction of the module cover 300 (e.g., the Z-axis direction of FIG. 3). At least a portion of the connector 235 may be exposed to the outside of the battery module 200 of FIG. 3 through the connector-accommodating hole 320.

The terminal-accommodating hole 310 may be formed to be adjacent to the first edge 301. For example, the terminal-accommodating hole 310 may be formed to be adjacent to the first edge 301 rather than the second edge 302. The connector-accommodating hole 320 may be formed to be adjacent to the second edge 302. For example, the connector-accommodating hole 320 may be formed to be adjacent to the second edge 302 rather than the first edge 301. In an embodiment, the connector-accommodating hole 320 may be formed in a groove shape in the second edge 302. The module cover 300 may include a terminal-accommodating hole 310 and a connector-accommodating hole 320, formed to be adjacent to the different edges 301 and 302, respectively. Since the venting guide portion 303 may be disposed diagonally with respect to the first edge 301 and the second edge 302, amounts of discharged materials transferred to the terminal-accommodating hole 310 and the connector-accommodating hole 320 may be reduced, and heat transfer of the battery module 200 may be delayed.

In an embodiment, the terminal-accommodating hole 310 and/or the connector-accommodating hole 320 may provide a path for flames, gases, and/or conductive particles generated in the battery module 200 to be discharged to the outside of the battery module 200. For example, a gap between the terminal busbar 223 inserted into the terminal-accommodating hole 310 and the module cover 300 and/or a gap between the connector 235 inserted into the connector-accommodating hole 320 and the module cover 300 may provide a path for flames, gases, and/or conductive particles to flow in the battery module 200.

Voltage of the terminal busbar 223 located in the terminal-accommodating hole 310 may be higher than voltage of the connector 235 located in the connector-accommodating hole 320. When flames, gases, and/or conductive particles generated in the battery module 200 are discharged to the outside of the battery module 200 through the terminal-accommodating hole 310, the flames, the gases, and/or the conductive particles may be transferred to the terminal busbar 223, causing an early voltage drop phenomenon of the battery module 200. For example, heat transferred to the terminal busbar 223 through the terminal-accommodating hole 310 may increase heat transfer between the battery modules 200 and/or the battery cells 100, and thermal runaway of the battery module 200 may occur.

The venting guide portion 303 may provide a path for flames, gases, and/or conductive particles generated in the battery module 200 (e.g., battery cell 100 of FIG. 1) to be discharged to the outside of the battery module 200. As flames, gases, and/or conductive particles are discharged to the outside of the battery module 200 through the venting guide portion 303, an increase in pressure in the battery module 200 may be reduced, and heat transfer between the battery cells 100 may be delayed. For example, the venting guide portion 303 may move at least a portion of flames, gases, and/or conductive particles along a designated path, thereby reducing amounts of the flames, the gases, and/or the conductive particles transmitted to the terminal busbar 223.

The venting guide portion 303 may form a passage connecting an internal space of a module housing (e.g., module housing 210 of FIG. 3) and an external space of the module housing 210. For example, the venting guide portion 303 may be a path for discharging gases generated in an accommodation space formed by the module housing 210 to the external space of the module housing 210. By the venting guide portion 303, amounts of gases, flames, and/or conductive particles in the battery module 200 may be reduced, and the amounts of the gases, the flames, and/or the to the terminal-conductive particles transmitted accommodating hole 310 may be reduced. In an embodiment, the venting guide portion 303 may be referred to as a venting portion.

In an embodiment, the venting guide portion 303 may be configured to rupture, based on a pressure in the battery module 200. The venting guide portion 303 may be a rupture portion formed in the module cover 300. For example, the venting guide portion 303 may be configured to be deformed (e.g., rupture), when a pressure and/or a temperature in the battery module 200 are higher than a specified value. The venting guide portion 303 may have a notched shape, a slit shape, or a half-cut shape configured to be ruptured based on a pressure in the battery module 200. For example, the venting guide portion 303 may be formed by punching or half-piercing a portion of the module cover 300. In another embodiment, the venting guide portion 303 may be a through-hole formed in the module cover 300.

The venting guide portion 303 may be disposed to be inclined with respect to the first edge 301 and the second edge 302. The venting guide portion 303 may be a notching or a slit formed in the module cover 300 in a direction, inclined with respect to the first direction (e.g., X-axis direction) and the second direction (e.g., Y-axis direction).

The venting guide portion 303 may be disposed to be inclined with respect to the first edge 301 and the second edge 302, to delay heat transfer between a plurality of battery cells (e.g., the battery cell 100 of FIG. 3). For example, the venting guide portion 303 may be disposed to be inclined with respect to the first edge 301 and the second amounts of gases, flames, and/or conductive edge 302, particles transferred to the terminal-accommodating hole 310 may be reduced, and a sudden voltage drop may be prevented. For example, amounts of gases, flames, and/or conductive particles transferred to the terminal-accommodating hole 310 may be reduced by an empty space formed by the venting guide portion 303.

In an embodiment, at least a portion of the venting guide portion 303 may be disposed to face the terminal-accommodating hole 310 or the connector-accommodating hole 320. As the venting guide portion 303 faces the terminal-accommodating hole 310 or the connector-accommodating hole 320, gases, flames, and/or conductive particles may be discharged to the outside of the battery module 200 along the venting guide portion 303 adjacent to the terminal-accommodating hole 310 or the connector-accommodating hole 320. As amounts of gases, flames, and/or conductive particles transmitted to the terminal-accommodating hole 310 may be reduced, the amounts of the gases, the flames, and/or the conductive particles transmitted to the terminal busbar 223 accommodated in the terminal-accommodating hole 310 and/or the connector 235 accommodated in the connector-accommodating hole 320 may be reduced.

The venting guide portion 303 may include a plurality of venting guide portions 330 and 340 intersecting with each other. For example, the venting guide portion 303 may include a first venting guide portion 330 and a second venting guide portion 340 intersecting the first venting guide portion 330. At least a portion of the first venting guide portion 330 may be located between the terminal-accommodating hole 310 and the connector-accommodating hole 320. The first venting guide portion 330 and the second venting guide portion 330 may be intersected to reduce amounts of gases, flames, and/or conductive particles transmitted to the terminal-accommodating hole 310. The first venting guide portion 330 may include a first end portion 330a facing the terminal-accommodating hole 310, and a second end portion 330b opposite the first end portion 330a and facing the connector-accommodating hole 320. In an embodiment, the first venting guide portion 330 may include a plurality of notches, a plurality of slits, or a plurality of half-cuts, located between the first end portion 330a and the second end portion 330b and spaced apart from each other. Description of the first venting guide portion 330 may be applied to the second venting guide portion 340.

The plurality of venting guide portions 330 and 340 may face the terminal-accommodating hole 310. For example, the first venting guide portion 330 may face the second terminal-accommodating hole 312. The second venting guide portion 340 may face the first terminal-accommodating hole 311.

The venting guide portions 330 and 340 may be provided in plural, respectively. For example, the first venting guide portion 330 may include a plurality of first venting guide portions 331 and 332 disposed to be parallel to each other. The second venting guide portion 340 may include a plurality of second venting guide portions 341 and 342 disposed to be parallel to each other. The number of the first venting guide portions 330 and the number of the second guide portions 340 may be designed selectively. For example, in FIG. 4, the first venting guide portion 330 and the second venting guide portion 340 are illustrated as having two structures, but are illustrative.

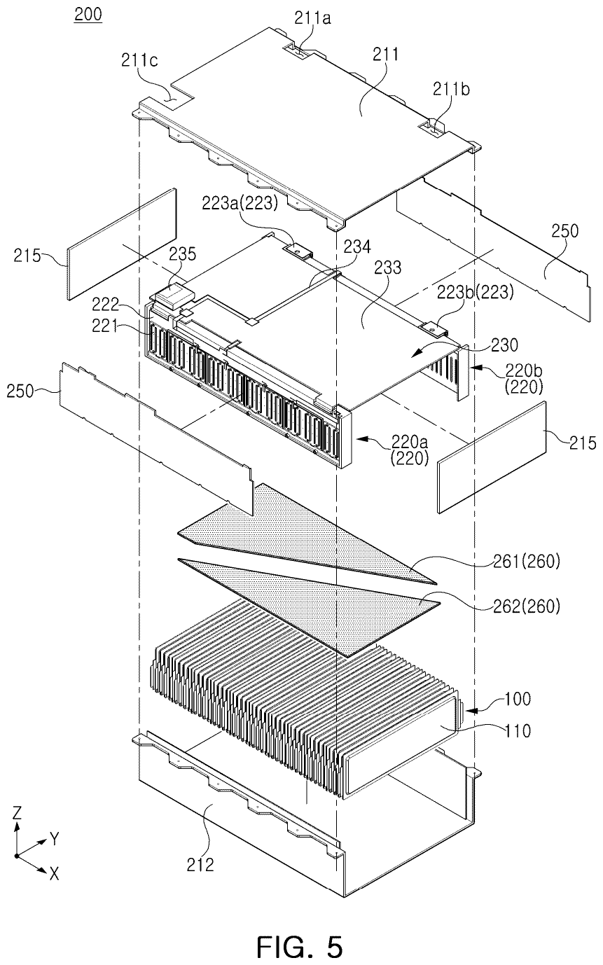

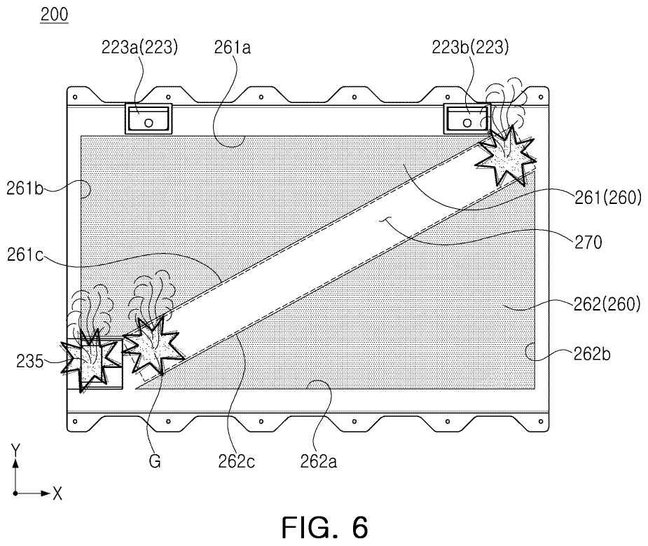

FIG. 5 is an exploded perspective view of a battery module according to another embodiment. FIG. 6 is a top view of the battery module of FIG. 5. For convenience of explanation, FIG. 6 is a top view of a battery module 200 with a module cover 211 omitted.

Referring to FIG. 5 and/or FIG. 6, a battery module 200 may include a cell assembly 101 including a plurality of battery cells (e.g., the battery cells 100 of FIG. 1), a module housing 210, a busbar assembly 220, a sensor assembly 230, and a heat-resistant sheet 260. At least some of descriptions of the cell assembly 101, the battery module 200, the module housing 210, the busbar assembly 220, and the sensor assembly 230 of FIGS. 2 and 3 may be applied to the cell assembly 101, the battery module 200, the module housing 210, the busbar assembly 220, and the sensor assembly 230 of FIGS. 5 and/or 6.

A module cover 211 may be formed to expose components of the battery module 200 to an outside of the battery module 200. For example, the module cover 211 may include terminal-accommodating holes 211a and 211b accommodating terminal busbars 223 (e.g., the terminal-accommodating holes 310 of FIG. 4). The module cover 211 may include a connector-accommodating hole 211c (e.g., the connector-accommodating hole 320 of FIG. 4) accommodating a connector 235.

The heat-resistant sheet 260 may delay heat transfer. For example, the heat-resistant sheet 260 may include a heat-resistant material and/or a fire-resistant material (e.g., mica and/or silica wool).

The heat-resistant sheet 260 may cover the cell assembly 101. For example, the heat-resistant sheet 260 may be located between the cell assembly 101 and the sensor assembly 230 (e.g., an insulation portion 233).

The heat-resistant sheet 260 may guide a path of movement of flames, gases, and/or conductive particles generated in the battery module 200 (e.g., the battery cell 100 of FIG. 1). For example, the heat-resistant sheet 260 may form a venting space 270. The venting space 270 may be a path through which discharged materials G (e.g., flames, gases, and/or conductive particles) generated from the cell assembly 101 move.

In an embodiment, the heat-resistant sheet 260 may be provided in plural. For example, the heat-resistant sheet 260 may include a first heat-resistant sheet 261 and a second heat-resistant sheet 262 spaced apart from the first heat-resistant sheet 261. The venting space 270 may be located between the first heat-resistant sheet 261 and the second heat-resistant sheet 262. For example, the venting space 270 may be an empty space located between the first heat-resistant sheet 261 and the second heat-resistant sheet 262, and of which at least a portion is located on the same plane (e.g., an X-Y plane) as the heat-resistant sheet 260.

The heat-resistant sheet 260 may be formed in a shape for reducing amounts of flames, gases, and/or conductive particles transmitted to the terminal-accommodating hole 211a and 211b. For example, the venting space 270 may be disposed to be inclined with respect to a first edge (e.g., the first edge 301 of FIG. 4) and a second edge (e.g., the second edge 302 of FIG. 4) of the module cover 211. The first heat-resistant sheet 261 and the second heat-resistant sheet 262 may be spaced apart with the venting space 270 therebetween.

The first heat-resistant sheet 261 may include a first outer side surface 261a substantially parallel to the first edge (e.g., the first edge 301 of FIG. 4), a second outer side surface 261b extending from the first outer side surface 261a and parallel to the second edge (e.g., the second edge 302 of FIG. 4), and a first inner side surface 261c inclined with respect to the first outer side surface 261a and the second outer side surface 261b. The second heat-resistant sheet 262 may include a third outer side surface 262a substantially parallel to the first edge (e.g., the first edge 301 of FIG. 4), a fourth outer side surface 262b extending from the third outer side surface 262a and parallel to the second edge (e.g., the second edge 302 of FIG. 4), and a second inner side surface 262c inclined with respect to the third outer side surface 262a and the fourth outer side surface 262b. The venting space 270 may be defined by the first inner side surface 261c and the second inner side surface 262c. For example, at least a portion of the venting space 270 may be surrounded by the first inner side surface 261c and the second inner side surface 262c. In an embodiment, the first outer side surface 261a of the first heat-resistant sheet 261 may face a terminal busbar 223 (e.g., a first terminal busbar 223a and a second terminal busbar 223b). One side of the venting space 270 may face the connector 235.

By the venting space 270, at least a portion of flames, gases, and/or conductive particles generated in the battery module 200 may be transferred to the connector-accommodating hole 211c accommodating the connector 235. By the venting space 270, amounts of flames, gases, and/or conductive particles transferred to the terminal-accommodating holes 211a and 211b may be reduced.

In an embodiment illustrated), the heat-resistant sheet 260 may have a through-hole forming the venting space 270. For example, the first heat-resistant sheet 261 and the second heat-resistant sheet 262 may be connected to each other in a shape with an empty space therebetween.

In an embodiment, the battery module 200 including the heat-resistant sheet 260 may include a module cover 211 in which the venting guide portion 303 of FIG. 4 is not formed.

In an embodiment, the module cover 300 of FIG. 4 may be applied to the module cover 211 of FIG. 5. For example, in an embodiment, the battery module 200 including the heat-resistant sheet 260 may include the module cover 300 including the venting guide portion 303 of FIG. 4. In an embodiment, the venting guide portion 303 may be located in an upper portion (e.g., in the Z-axis direction) of the venting space 270. For example, at least a portion of the venting guide portion 303 may overlap the venting space 270. The discharged materials G passing through the venting space 270 may be transferred to the venting guide portion 303.

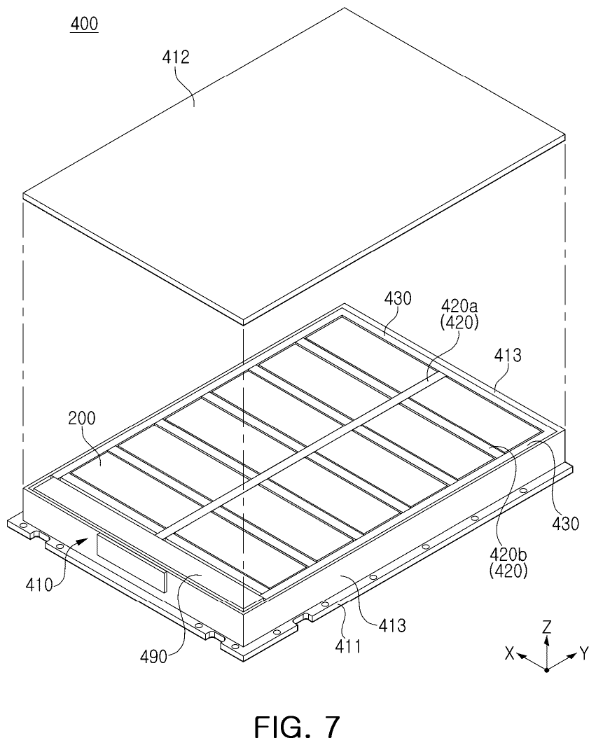

FIG. 7 is an exploded perspective view of a battery pack according to an embodiment.

Referring to FIG. 7, a battery pack 400 may include a plurality of battery modules 200 and a pack frame 410 accommodating the plurality of battery modules 200. The description of the battery module 200 described previously may be applied to a battery module 200 of FIG. 7. For example, in an embodiment, the battery module 200 of FIG. 7 may include the module cover 300 of FIG. 4. In an embodiment, the battery module 200 of FIG. 7 may include a heat-resistant sheet 260 and a venting space 270.

The pack frame 410 may accommodate a component of the battery pack 400 (e.g., a battery module 200). The pack frame 410 may include a bottom member 411 supporting the battery module 200, a pack cover 412 covering the battery module 200, and a pack side wall 413 surrounding at least a portion of the bottom member 411 and the pack cover 412. The bottom member 411 may support the battery module 200.

The pack frame 410 may include a bulkhead 420 crossing at least a portion of the plurality of battery modules 200. For example, an accommodation space of the pack frame 410 may be divided into a plurality of spaces by the bulkhead 420. The bulkhead 420 may be installed to cross the accommodating space to reinforce rigidity of the pack frame 410. In an embodiment, the bulkhead 420 may include a first bulkhead 420a crossing a plurality of battery cells 100, and a plurality of second bulkheads 420b substantially perpendicular to the first bulkhead 420a.

In an embodiment, the battery pack 400 may include a duct member 430. The duct member 430 may include an exhaust space to provide a path for gases and/or flames discharged from the battery module 200. The duct member 430 may be disposed in the pack frame 410. The duct member 430 may surround at least a portion of the battery module 200. For example, gases and/or flames generated from a battery cell of the battery module 200 (e.g., the battery cell 100 of FIG. 1) may be transmitted to an outside of the battery pack 400 through the exhaust space of the duct member 430. In the present disclosure, the duct member 430 may be referred to as an exhaust duct or an exhaust member.

The battery pack 400 may include a battery control unit 490 controlling the battery module 200. The battery control unit 490 may be disposed in the pack frame 410. The battery control unit 490 may include a battery management system (BMS). Since a configuration of the battery control unit 490 is known in various forms, a detailed description thereof will be omitted. In an embodiment, the battery control unit 490 may be referred to as a processor.

A structure of the battery pack 400 of FIG. 7 is illustrative. For example, the number of battery modules 200 included in the battery pack 400, a structure of the pack frame 410 and/or a structure of the duct member 430 may be designed selectively.

The contents described above may be merely examples of applying the principles of the present disclosure, and other configurations may be further included without departing from the scope of the present disclosure.

Although the embodiments of the present disclosure have been described above, the scope of the rights of the present disclosure is not limited thereto, and it will be apparent to those skilled in the art that various modifications and variations are possible in the scope that does not depart from the technical idea of the present disclosure described in the claims. For example, the present disclosure may be implemented by deleting some components from the above-described embodiments, and each of the embodiments may be implemented by combining with each other.

According to an embodiment of the present disclosure, heat transfer of a battery module may be delayed.

Only specific examples of implementations of certain embodiments may be described. Variations, improvements and enhancements of the disclosed embodiments and other embodiments may be made based on the disclosure of this patent document.

What is claimed is:

1. A battery module comprising:
a cell assembly including a plurality of battery cells;
a busbar assembly including an internal busbar electrically connected to the plurality of battery cells, and a terminal busbar electrically connected to the internal busbar; and
a module housing including a module cover covering the cell assembly,
wherein the module cover includes:
a first edge;
a second edge of which at least a portion is perpendicular to the first edge;
a terminal-accommodating hole accommodating the terminal busbar;
a connector-accommodating hole spaced apart from the terminal-accommodating hole; and
a venting guide portion disposed to be inclined with respect to the first edge and the second edge, and of which at least a portion faces the terminal-accommodating hole or the connector-accommodating hole.

2. The battery module of claim 1, wherein the venting guide portion includes:
a first venting guide portion of which at least a portion is located between the terminal-accommodating hole and the connector-accommodating hole, and
a second venting guide portion intersecting the first venting guide portion.

3. The battery module of claim 2, wherein the first venting guide portion includes a plurality of first venting guide portions disposed to be parallel to each other, and
the second venting guide portion includes a plurality of second venting guide portions disposed to be parallel to each other.

4. The battery module of claim 2, wherein the terminal-accommodating hole includes a first terminal-accommodating hole and a second terminal-accommodating hole spaced apart from the first terminal-accommodating hole,
the first venting guide portion faces the second terminal-accommodating hole, and
the second venting guide portion faces the first terminal-accommodating hole.

5. The battery module of claim 1, wherein the venting guide portion has a notched shape or a half-cut shape configured to rupture, based on pressure in the battery module.

6. The battery module of claim 1, further including:
a sensor assembly including a flexible printed circuit board electrically connected to a sensing terminal configured to sense information of the internal busbar, and a connector electrically connected to the flexible printed circuit board and accommodated in the connector-accommodating hole.

7. The battery module of claim 1, wherein the terminal-accommodating hole is closer to the first edge than the second edge, and
the connector-accommodating hole is closer to the second edge than the first edge.

8. The battery module of claim 1, further including a heat-resistant sheet covering the cell assembly.

9. The battery module of claim 8, wherein the heat-resistant sheet includes a first heat-resistant sheet and a second heat-resistant sheet spaced apart from the first heat-resistant sheet,
the battery module further includes a venting space located between the first heat-resistant sheet and the second heat-resistant sheet, and
the venting guide portion is located in an upper portion of the venting space.

10. The battery module of claim 1, wherein each of the plurality of battery cells includes an electrode assembly, a pouch accommodating the electrode assembly, and an electrode tab connected to the electrode assembly.

11. A battery module comprising:
a cell assembly including a plurality of battery cells;
a busbar assembly including an internal busbar electrically connected to the plurality of battery cells, and a terminal busbar electrically connected to the internal busbar;
a module housing including a module cover covering the cell assembly and an accommodation portion accommodating the cell assembly; and
a heat-resistant sheet located between the cell assembly and the module cover,
wherein the module cover includes a first edge and a second edge of which at least a portion is perpendicular to the first edge, and
wherein the heat-resistant sheet includes a first heat-resistant sheet and a second heat-resistant sheet, spaced apart from each other, with a venting space interposed therebetween and disposed to be inclined with respect to the first edge and the second edge.

12. The battery module of claim 11, wherein the first heat-resistant sheet includes a first outer side surface parallel to the first edge, a second outer side surface extending from the first outer side surface and parallel to the second edge, and a first inner side surface inclined with respect to the first outer side surface and the second outer side surface,
the second heat-resistant sheet includes a third outer side surface parallel to the first edge, a fourth outer side surface extending from the third outer side surface and parallel to the second edge, and a second inner side surface inclined with respect to the third outer side surface and the fourth outer side surface, and
at least a portion of the venting space is surrounded by the first inner side surface and the second inner side surface.

13. The battery module of claim 12, further including a sensor assembly including a flexible printed circuit board electrically connected to a sensing terminal configured to sense information of the internal busbar, and a connector electrically connected to the flexible printed circuit board, and
wherein the heat-resistant sheet is located between at least a portion of the cell assembly and the sensor assembly.

14. The battery module of claim 12, wherein the module cover includes a venting guide portion disposed to be inclined with respect to the first edge and the second edge, and
the venting guide portion is located in an upper portion of the venting space.

15. A battery pack comprising:
a plurality of battery modules; and
a pack frame accommodating the plurality of battery modules,
wherein each of the plurality of battery modules includes:
a cell assembly including a plurality of battery cells;
a busbar assembly an internal including busbar electrically connected to the plurality of battery cells, a busbar frame supporting the internal busbar, and a terminal busbar electrically connected to the internal busbar; and
a module housing including a module cover covering the cell assembly and an accommodation portion accommodating the cell assembly, and
wherein the module cover includes:
a first edge;
a second edge of which at least a portion is perpendicular to the first edge;
a terminal-accommodating hole accommodating the terminal busbar;
a connector-accommodating hole spaced apart from the terminal-accommodating hole; and
a venting guide portion disposed to be inclined with respect to the first edge and the second edge, and of which at least a portion faces the terminal-accommodating hole or the connector-accommodating hole.
